(19) United States
(12) Patent Application Publication
(10) Pub. No.: US 2015/0145713 A1
(43) Pub. Date: May 28, 2015

(54) RETRO-REFLECTIVE RADAR PATCH ANTENNA TARGET FOR ARTICULATED VEHICLE TRAILER SENSING

(71) Applicant: THE REGENTS OF THE UNIVERSITY OF MICHIGAN, Ann Arbor, MI (US)

(72) Inventors: John M. MADDOX, Ann Arbor, MI (US); William BULLER, Dexter, MI (US)

(21) Appl. No.: 14/551,736

(22) Filed: Nov. 24, 2014

Related U.S. Application Data
(60) Provisional application No. 61/908,845, filed on Nov. 26, 2013.

(51) Int. Cl. G01S 13/93; G01S 13/75

(52) U.S. Cl. CPC G01S 13/931; G01S 13/751; G01S 2013/9332
USPC 342/47

(57) ABSTRACT

A vehicle detection system for determining the position of a trailing section relative to a forward section of a vehicle, such as a tractor-trailer combination. The trailing section is pivotally coupled to the forward section for driving movement therewith. The vehicle detection system includes a central controller and a detection system connectable to the forward section of the vehicle and operably coupled to the central controller. The detection system outputs a detection signal. A target device is connectable to the trailing section and configured to receive the detection signal from the detection system and output a unique return signal to the detection system. The detection system receives the return signal and transfers the return signal or other indicative signal for processing by the central controller, whereby the central controller determines position information of the trailing section, for potential use by a DSRC.

### CROSS-REFERENCE TO RELATED APPLICATIONS

This application claims the benefit of U.S. Provisional Application No. 61/908,845, filed on Nov. 26, 2013. The entire disclosure of the above application is incorporated herein by reference.

### FIELD

The present disclosure relates to vehicle sensing and, more particularly, relates to vehicle position sensing of articulated vehicles using a retro-reflective radar patch antenna target system.

### BACKGROUND AND SUMMARY

This section provides background information related to the present disclosure which is not necessarily prior art. This section provides a general summary of the disclosure, and is not a comprehensive disclosure of its full scope or all of its features.

Dedicated short-range communication (DSRC) is a one-way or two-way short- to medium-range wireless communication standard specifically designed for automotive use and includes a corresponding set of protocols and standards. DSRC is particularly useful as a means to enable peer-to-peer communication between vehicles for enhanced safety and operation. For example, DSRC can be used for such purposes as an emergency warning system for vehicles, cooperative adaptive cruise control, cooperative forward collision warning, intersection collision avoidance, approaching emergency vehicle warning, vehicle safety inspections, transit or emergency vehicle signal priority, electronic parking payments, commercial vehicle clearance and safety inspections, in-vehicle signing, rollover warning, probe data collection, highway-rail intersection warning, electronic toll collection, and the like.

In particular, DSRC is useful in communicating vehicle position, in at least a one-way format, to prevent or at least minimize the potential for vehicle collisions. Generally, this can be achieved by broadcasting vehicle information of one vehicle to other vehicles. Typically, this vehicle information can include the location, speed, and heading of the vehicle; however, such location information is often related to a specified point or predetermined vehicle footprint.

However, in the case of oversized vehicles and/or articulating vehicles, such as tractor-trailer configurations (e.g. semi-trucks and oversized carriers), determining position data during operation can be difficult. As an articulated vehicle turns, it can often be difficult to determine the precise location of all portions of the articulated vehicle and, as such, predetermined vehicle footprints may not accurately represent the true location of all portions of the articulated vehicle.

Accordingly, there exists a need in the relevant art to determine the actual position of an articulated vehicle for purposes of DSRC and other vehicle systems. Furthermore, there exists a need in the relevant art to measure the actual position of a trailer of an articulated vehicle. Still further, there exists a need in the relevant art to overcome the disadvantages of the prior art.

According to the principles of the present teachings, a vehicle detection system is provided for determining the position of a trailing section relative to a forward section of a vehicle, such as a tractor-trailer combination. The trailing section is pivotally or otherwise articulatingly coupled to the forward section for driving movement therewith. The vehicle detection system may include a central controller and a detection system connectable to the forward section of the vehicle and operably coupled to the central controller. The detection system can output a detection signal. A target device can be connectable to the trailing section and configured to receive the detection signal from the detection system and output a unique return signal to the detection system. The detection system can receive the return signal and transfer the return signal or other indicative signal for processing to the central controller, whereby the central controller can determine position information of the trailing section, for potential use by a DSRC system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a typical tractor-trailer vehicle combination in a potential collision configuration with an adjacent vehicle;

FIG. 2 is a schematic diagram illustrating a tractor-trailer vehicle combination employing the position detection system according to the principles of the present teachings;

FIG. 3 is a graph illustrating the measured range, c, for articulation angles from 75 to 65 degrees, showing that knowing the range to a few centimeters, allows the system to characterize the articulation angle within a couple of degrees; and

FIG. 4 is a schematic diagram illustrating a Van Atta array design for the retro-reflection patch antenna target according to the principles of the present teachings having an element spacing dependent on the wavelength, λ, for a W-band radar, operating at 77 GHz, λ=3.9 mm.

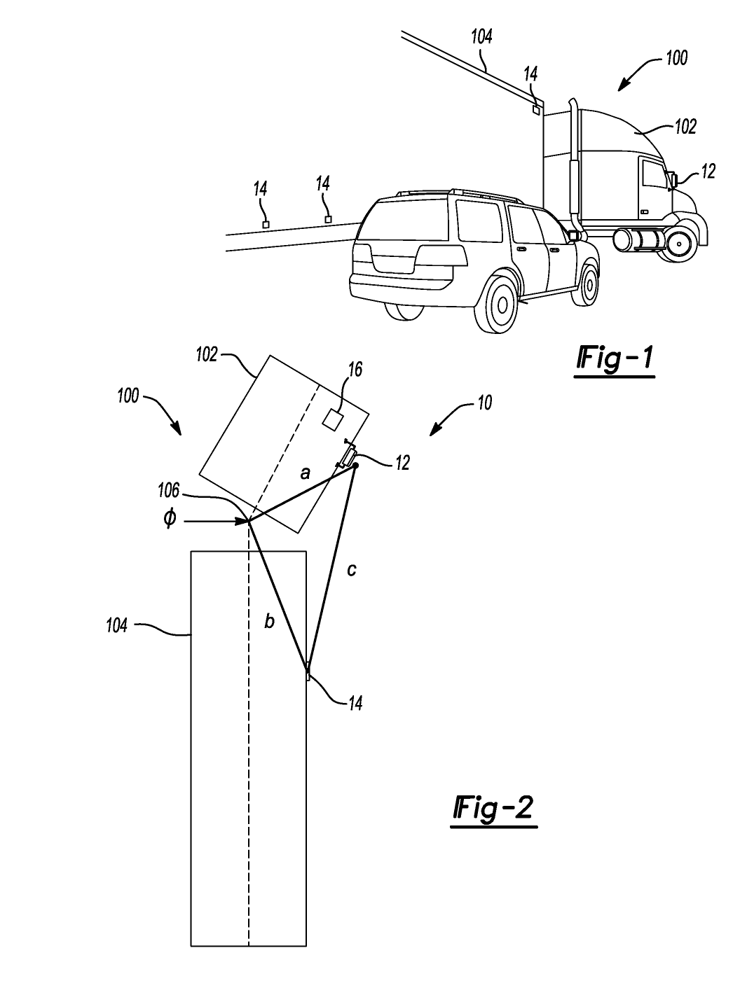

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Many modern vehicles are equipped with onboard radar systems, typically RF blind-spot detectors, for use as proximity sensors and/or collision detectors. These radar systems output a detection beam whose return signal can be used to detect the presence of other objects or obstructions. However, according to the principles of the present teachings, these radar systems, together with reflector systems, can be used to actively detect the position, location, and/or articulation angle (generally referred to as vehicle disposition) of oversized and/or articulating vehicles, such as tractor-trailer combinations.

The DSRC on the tractor can communicate trailing section 104's disposition, but needs to make the measurement. In general, trailing section 104 must be treated as external to the solution, as it may be transferred amongst multiple users and any components will be lost.

According to the principles of the present teachings, a detection system 10 can be provided for use with an existing or add-on radar system 12 that is capable of detecting position and/or distance information from a retro-reflective radar patch antenna target or other target device 14. Detection system 10 can be operably coupled to an articulated vehicle 100, such as a tractor-trailer combination (e.g. semi-truck), having a forward section 102 and a trailing section 104. In some embodiments, trailing section 104 is operably coupled to forward section 102 at a pivot or hitch assembly 106. It should be understood, however, that hitch assembly 106 can comprise any one of a number of connection systems, including a multi-linkage assembly. In such cases, the principles of the present teachings can be based upon an effective hitch or pivot location 106. It should also be understood that pivot location 106 can comprise more than one single pivot point. The present teachings are equally applicable to complex articulated vehicles having more than a single pivot point. A controller or central processing unit 16 can be used to obtain information from detection system 12 and determine position information of trailing section 104 and/or roadway or off-vehicle obstructions, objects, or items of interest.

It should be understood that variations exists in accordance with the present teachings. For example, it should be understood that a plurality of target devices 14 can be used along portions of trailing section 104 to refine or otherwise improve detection thereof, including a plurality of longitudinally-disposed target devices 14 extending along a length of trailing section 104 and, additionally, a plurality of target devices 14 disposed at various elevations along trailing section 104 for detection of trailing section 104 in three-dimensions. This can be particularly useful when determining lateral and elevational obstructions.

Modern articulated vehicles, such as tractor-trailer combinations, often employ radar systems 12, such as RF blind-spot detectors. However, according to the principles of the present teachings, target device 14 can be used to determine the disposition of trailing section 104. In some embodiments, target device 14, such as a retro-reflective radar patch antenna, can be physically attached or coupled to trailing section 104. Target device 14 can be configured to employ either polarization or amplitude modulation to distinguish their reflections from other radar reflections in the scene, such as obstructions and/or vehicles. To this end, one can employ a miss-matched filter that correlates reflections with a particular modulation. The term miss-matched is used, because a radar typically looks for reflections of the signal it transmits using a matched-filter.

A coded retro-reflector on each side of trailing section 104 would provide the blind-spot detection radar 12 the means to determine the angle, φ (see FIG. 2) of trailing section 104 about hitch 106. The distance from hitch 106 to the blind-spot detection radar 12 and the coded retro-reflector 14 are fixed. The blind-spot detection radar 12 can thus measure the distance to the retro-reflector and calculate angle, φ, of hitch 106.

To estimate the articulation angle, φ, the system can rely on the following relationship:

$$φ = a cos ( \frac{{a}^{2} + {b}^{2} + {c}^{2}}{2 ab} )$$

This can be expressed for multiple reflectors as well; however, only one is used here for simplicity. The measurement of the range, c, to the reflector is given by:

c=2ab cos(φ)−(a²+b²)

The rate of change of the angle induces the following change in the measurement

$$\frac{d c}{d φ} = - 2 ab sin ( φ )$$

The solution of an optimal location for the reflector can be chosen by evaluating the maximum of the above equation for a given tractor-trailer geometry.

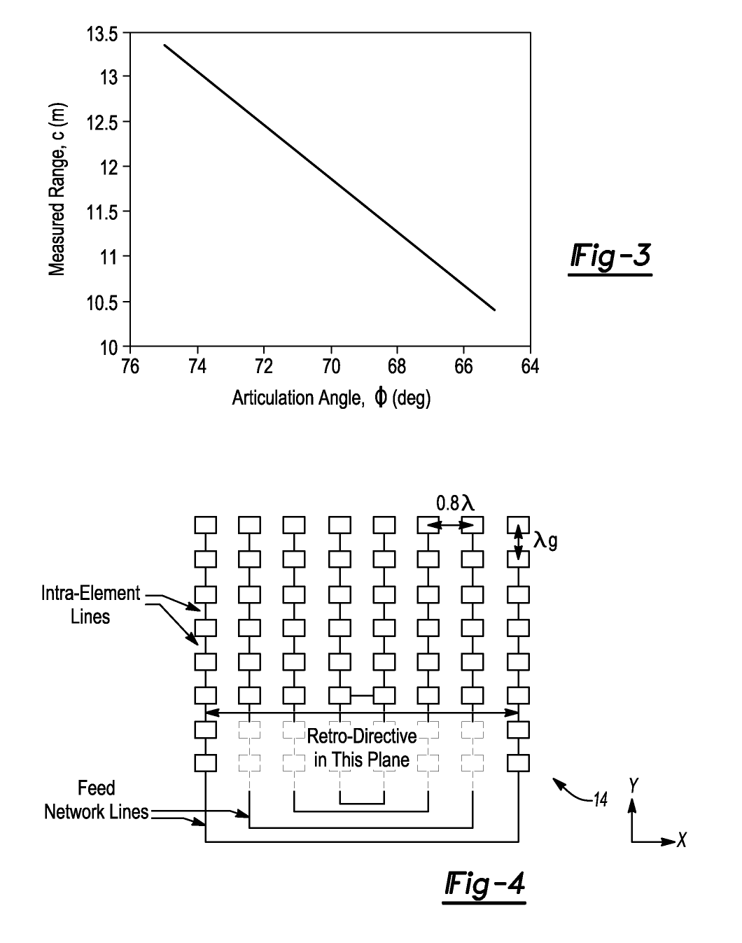

Following the system in FIG. 2, the distances a and b are set to 3 meters, the initial articulation is set to 75 degrees, then as the truck turns by 10 degrees, the reflector range changes by about 3 m, as plotted in FIG. 3. For reference, a radar with 1 GHz of bandwidth, can provide range resolution on the order of 15 cm. The measured range, c, for articulation angles from 75 to 65 degrees, shows that knowing the range to within a few centimeters, allows the system 10 to characterize the articulation angle within a couple of degrees.

To track the angle of articulation, the system can make measurements on the order of a few measurements per second. This is sufficient for a track filter to increase the accuracy of the measurement and update the DSRC when prompted. In this case, the track filter needs to model the measurement of the range and range rate of the reflector, expressed in the above equations. While these equations are fairly simple, they are not linear and, thus may require a non-linear filter, such as an extended Kalman filter.

The output of the track filter is the articulation angle, φ, and the articulation angle rate, \dot{φ}.

Enabling Technologies

The enabling technologies for this product are the existing blind-spot detection radars, and an inexpensive reflecting component: van Atta array, or RFID tag. A network of patch antennas, van Atta array (see FIG. 4), can be printed to produce RF retro-reflectors with diode switches to enable signal modulation. As illustrated in FIG. 4, the Van Atta array design for retro-reflection can comprise element spacing dependent on the wavelength, λ. For example, a W-band radar, operating at 77 GHz, would have a λ=3.9 mm.

In automotive applications, the vehicles, roadways and roadside signs, reflect RF waves with the same polarization as transmitted (co-polarization). Therefore, there is an added advantage to enabling the coded retro-reflector to return energy in the cross-polarization channel, to further distinguish its signature.

RFID tags are commercially available, though typically designed for lower frequencies. However, this is not due to a physical limitation.

There are many applications for retro-reflective antennas as aids to on-board vehicle radar systems. Generally, these inexpensive passive coded retro-reflective antennas could be placed on both moving and stationary objects so that radar-equipped vehicles can positively identify objects to avoid.

For example, current radar systems have difficulty classifying stationary metallic objects, such as bridge abutments, guardrails, and other roadside “furniture”, as well as expansion joints, manhole covers, and other permanent road features. The addition of the coded antenna 14, specific to the type of object, would clearly identify that object as something to avoid entirely, something that can be driven next to, and/or something that can be safely driven over.

Additionally, temporary and semi-permanent deployments of such devices as construction cones and signs, construction trench plates, construction trailers, construction equipment, and even construction personnel, could be equipped with these antennas to identify them as objects to avoid. Maintenance equipment, devices, and personnel could be similarly equipped.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle detection system for determining the position of a trailing section relative to a forward section of a vehicle, the trailing section being pivotally coupled to the forward section for driving movement therewith, said vehicle detection system comprising:
a central controller;
a detection system connectable to the forward section of the vehicle and operably coupled to said central controller, said detection system outputting a detection signal; and
a target device connectable to the trailing section, said target device being configured to receive said detection signal from said detection system and output a unique return signal to said detection system,
wherein said detection system receives said return signal and transfers said return signal for processing by said central controller, said central controller determining position information of the trailing section.

2. The vehicle detection system according to claim 1 wherein said detection system comprises an onboard collision detection system.

3. The vehicle detection system according to claim 1 wherein said detection system comprises an RF blind-spot detector.

4. The vehicle detection system according to claim 1 wherein said target device comprises an RFID.

5. The vehicle detection system according to claim 1 wherein said target device comprises a patch antenna.

6. The vehicle detection system according to claim 1 wherein said target device comprises a retro-reflective radar patch target.

7. The vehicle detection system according to claim 1 wherein said target device receives said detection signal and outputs a polarized unique return signal.

8. The vehicle detection system according to claim 1 wherein said target device receives said detection signal and outputs an amplitude modulation unique return signal.

9. The vehicle detection system according to claim 1 wherein said target device is a van Atta array target.
